(19) United States
(12) Patent Application Publication
(10) Pub. No.: US 2017/0078585 A1
(43) Pub. Date: Mar. 16, 2017

(54) Process and system in which the user can enhance their selfie photos before they are taken

(71) Applicant: Melinda Wells, OXFORD, MS (US)

(72) Inventor: Melinda Wells, OXFORD, MS (US)

(21) Appl. No.: 15/265,824

(22) Filed: Sep. 14, 2016

Related U.S. Application Data
(60) Provisional application No. 62/218,090, filed on Sep. 14, 2015.

(51) Int. Cl. H04N 5/232; G06T 11/60; G06T 11/40

(52) U.S. Cl. CPC H04N 5/23296; H04N 5/23293; G06T 11/40; G06T 11/60

(57) ABSTRACT

The current invention is process and system that works with a camera device like a smartphone that allows people to enhance their selfie photos before they are taken. It applies blemish correction and/or a filter if chosen by the user. It includes a numbered scale for the blemish corrections, allowing the user to adjust the strength of automatic corrections.

### CROSS-REFERENCES TO RELATED APPLICATIONS (IF ANY)

This application claims the priority date of Provisional Application No. 62/218,090 filed on Sep. 14, 2015.

### BACKGROUND

1. Field of the Invention

The present invention relates to a process to allow users to edit selfies and in more particularly prior to the picture being taken.

2. Description of Prior Art

When taking photos and selfies, smartphone users typically have to download multiple applications in order to set desired blemish corrections and filters. Having to take the photo and then set all filters and blemish corrections after-the-fact can be annoying and frustrating. Users have no way of enhancing the images before their picture is taken. Further, when taking selfies, it may be difficult to fit every person in the camera at the same time. A suitable solution is desired.

There is still room for improvement in the art.

### SUMMARY OF THE INVENTION

The current invention is a smartphone computer application and process which allows people to enhance their selfie photos before they are taken. It applies blemish correction and/or a filter if chosen by the user. As designed it includes a numbered scale for the blemish corrections, allowing the user to adjust the strength of automatic corrections. The invention offers use from both the front and rear cameras on a smartphone which allows users to take selfies with ease, convenience, and enhancements.

This mobile software application assists people to make better pictures by a prefixing the photo before the pictures even taken. The concept is in direct opposition to the standard pic apps which allow people to fix their pictures after the pictures are been taken. Thus, the product is both unique and an interesting takes on assisting people to make better photos of themselves and their friends

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 shows a sample of a login screen;

FIG. 3 shows the view of the desired picture prior to editing;

FIG. 4 displays the editing spots;

FIG. 5 displays the edited view;

FIG. 6 displays the final picture; and

FIG. 7 shows the camera on the smartphone.

### DESCRIPTION OF THE PREFERRED EMBODIMENT

There are a number of significant design features and improvements incorporated within the invention.

The current invention is a process and system in which the user can enhance their selfie photos before they are taken.

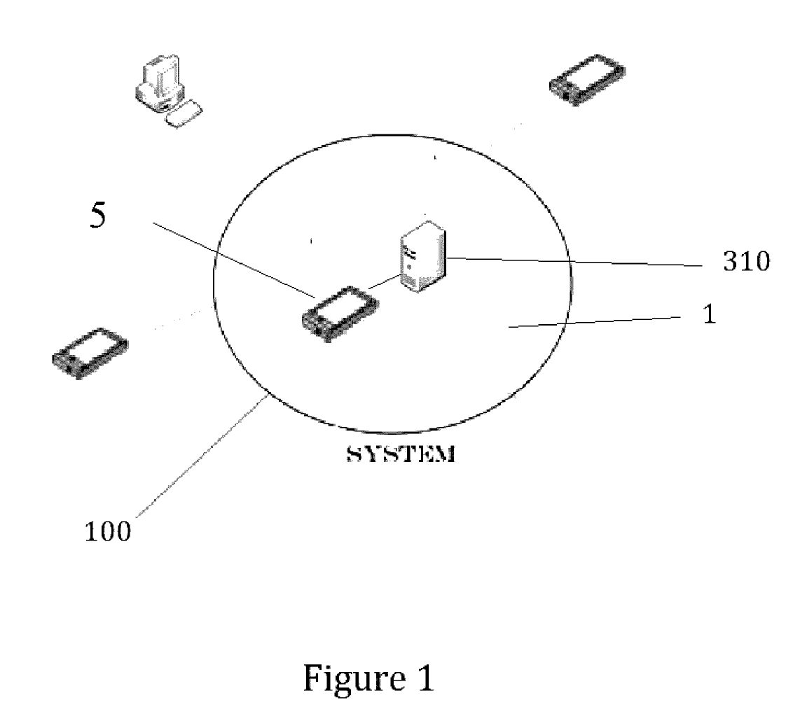

FIG. 1 displays the preferred embodiment of the system architecture 1. The system 1 is located on a computing device like a smartphone 5. It can send or receive data from other devices directly though a wireless connection like Bluetooth or through an Internet, Intranet and/or Wireless network 100.

In FIG. 1, the system 1 is accessed and run from a user's computing device which in the preferred embodiment is a smartphone 5. The smartphone 5 will some version of a camera 50, CPU, CPU memory, local hard disk, keyboard/keypad/input and screen 60.

The system 1, data and processing code can reside in the non-transitory memory 310 of the computing devices which can be a smartphone 5. The system 1 in the preferred embodiment would be written to act like a smart phone application (app).

The computer application can be written in any standard computer language used to create computer applications for a computing device and can be used for any computing device that has a camera 50 or can be attached to a camera 50. It also can be used with any type of smartphone and operating system.

### BRIEF OVERVIEW

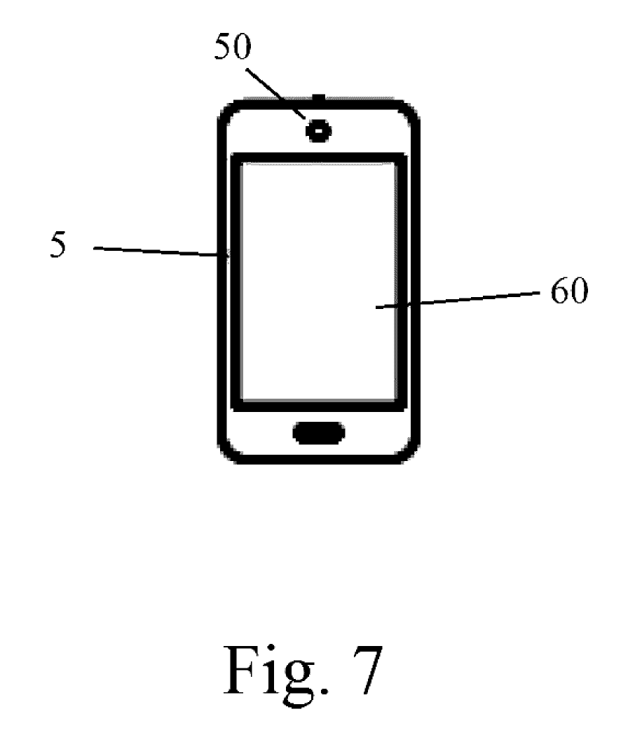

This current invention is a system 1 and computer application (app) that automatically adjusts the front or rear camera when the intended photo target is too large. The application 1 can also allow users to enhance photos before they are taken with blemish corrections and desired filters. The front camera 50 and screen 60 are shown in FIG. 7.

Individuals using the application can experience the ease and convenience of adjustable and automatic editing, eliminating the need to spend time after taking a photo removing red-eye and other unwanted blemish effects.

In the preferred embodiment, the system would have a numbered scale for blemish corrections and filters in order to allow users to select the strength of their automatic corrections.

Operation

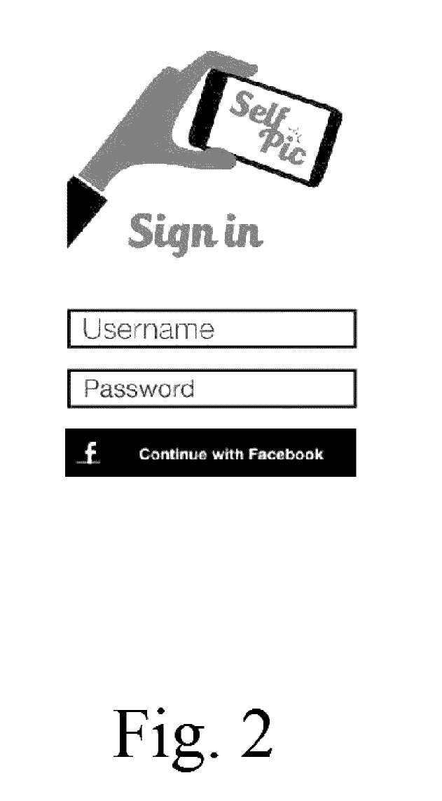

The users would sign-in directly or using social logins as shown in FIG. 2 with the user registering the app,

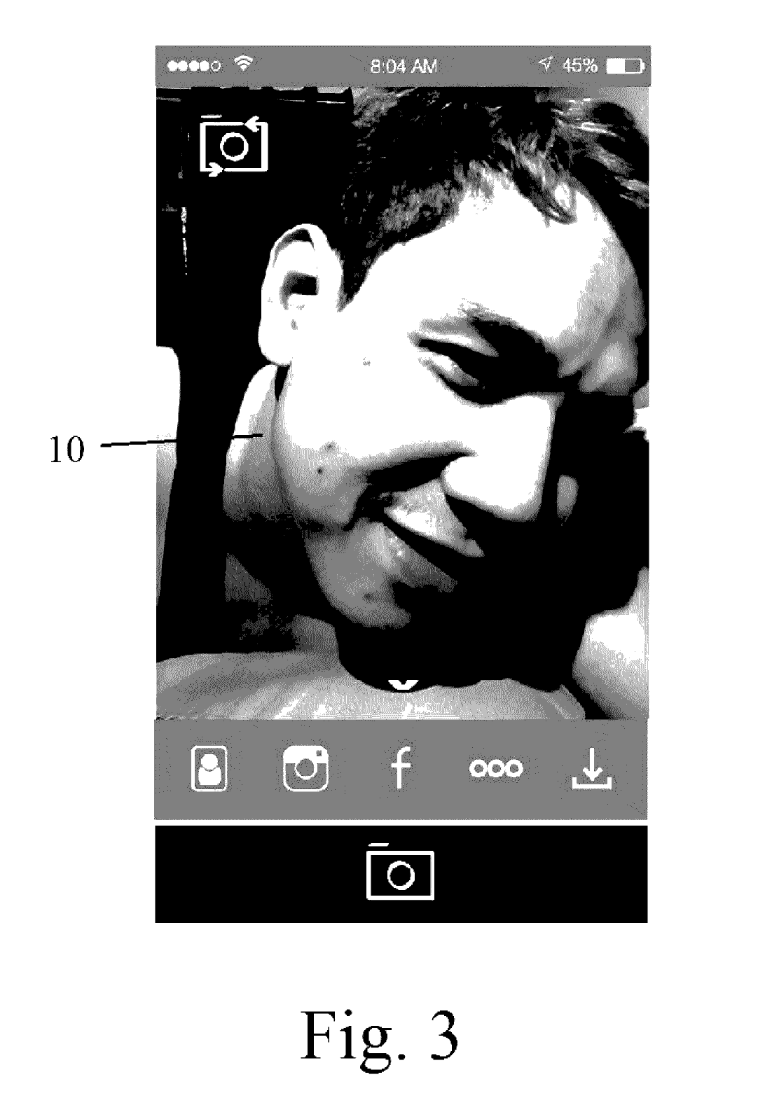

A user uses their smartphone 5 to produce an image 10 which they want to take a photo of. FIG. 3 shows the image 10. The system 1 will automatically adjust the size of the image 10. The face in the image 10 in FIG. 3 has blemishes on it.

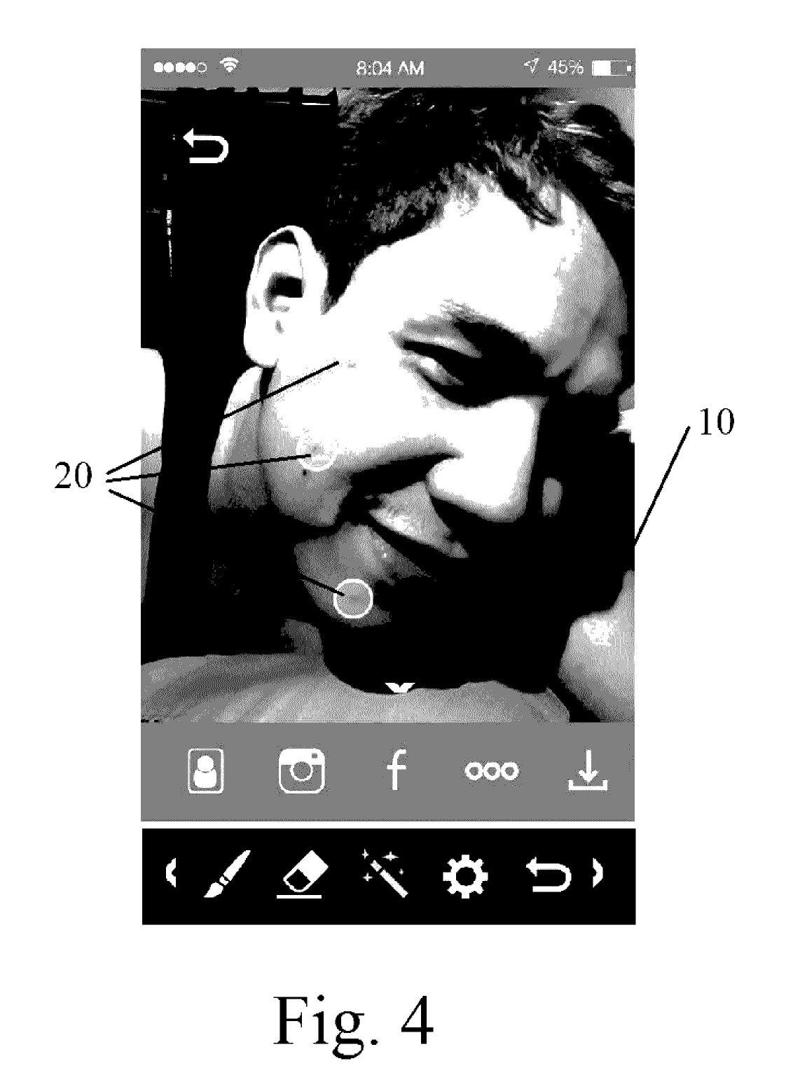

The user uses the system 1 to review the image 10 and identify places 20 on the image 10 that the user wants to make changes to, such as clearing blemishes as shown in FIG. 4. The system 1 will have a set of tools located on its screens such as an adjustable filter, paint, erase, fill with a color, copy and paste, tools and a undo functions. The system 1 will have multiple tools that can be used to edit the identified places 20.

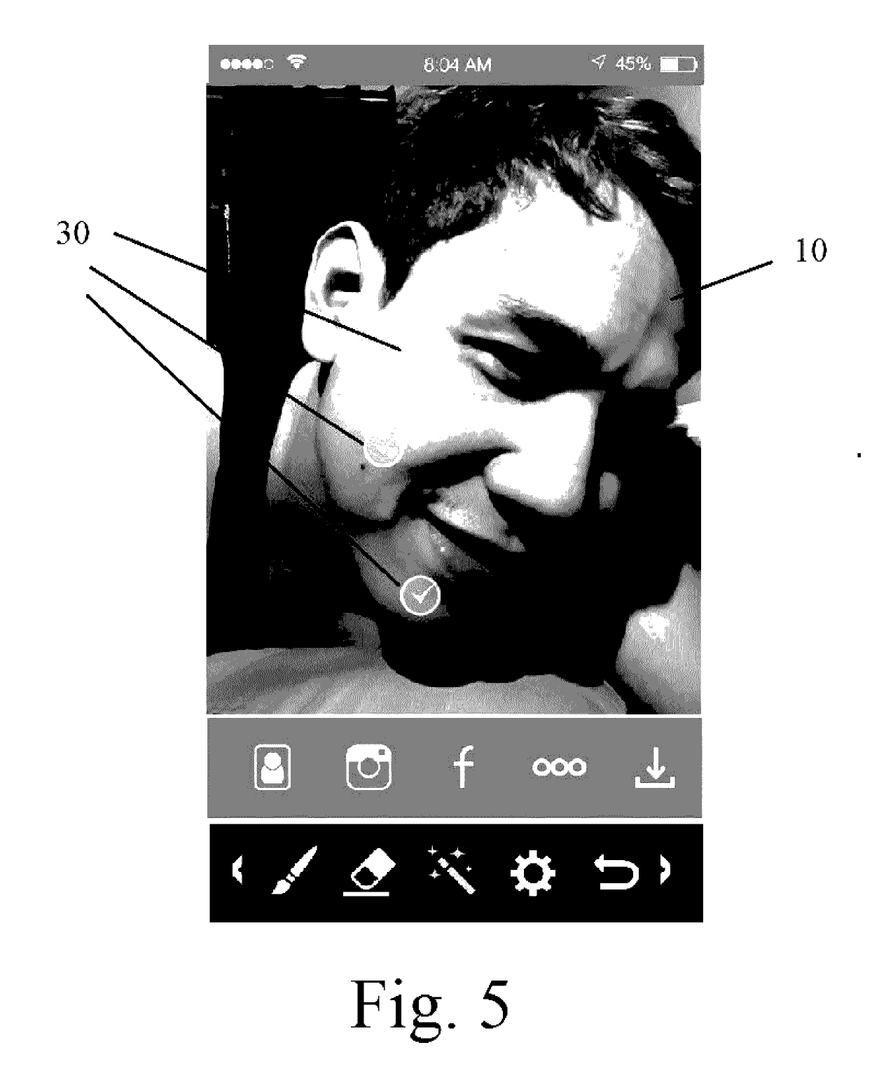

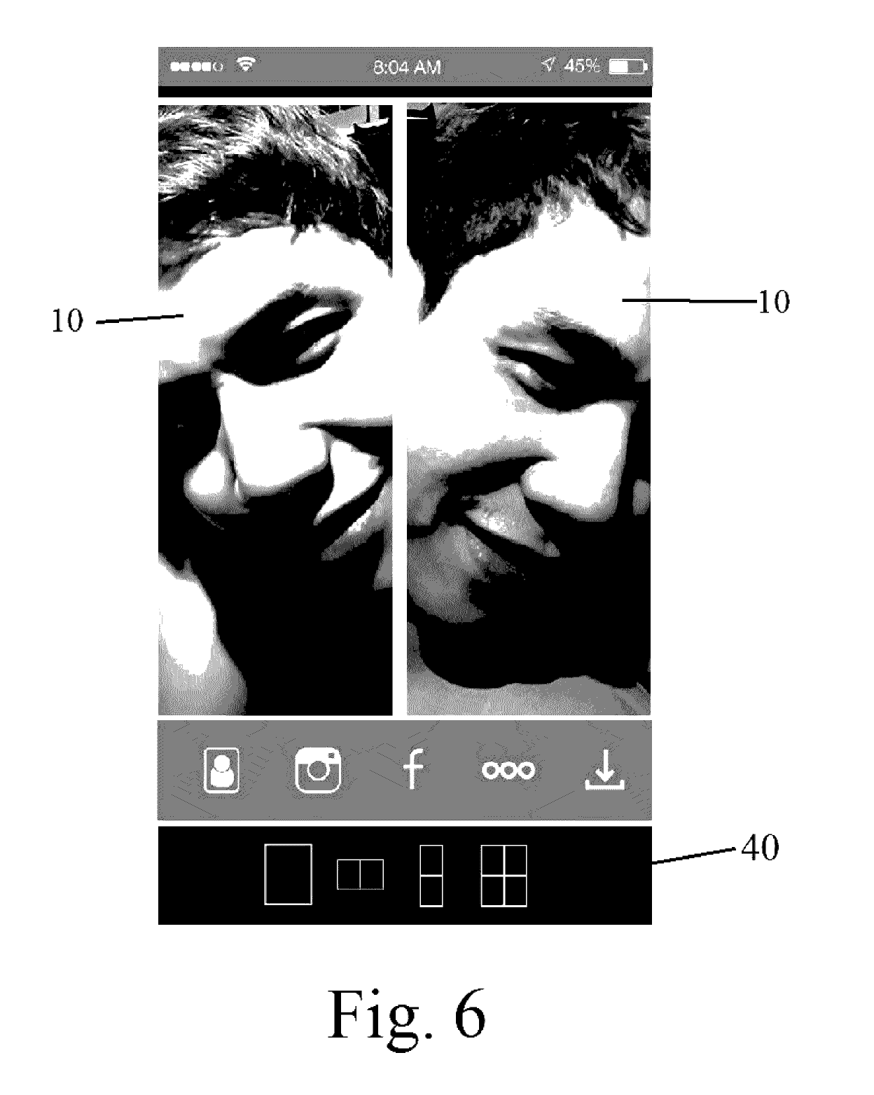

Once the identified places 20 have been edited, the system 1 will signify that it has been done with a marker 30 such as a check as shown in FIG. 5. Once done and approved the final image is produced as shown in FIG. 6. At this point, the photo can be taken, stored on the smartphone, or downloaded or sent out to other users.

As shown in FIG. 6, the system 1 has a function for a split screen with multiple images. The screen choices are selected from a selection box 40 as shown in FIG. 6.

### CONCLUSION

This system and application allows for everyone to see the best version of person being photographed. The customizable photo system and application allows a user to take care of those embarrassing blemishes before anyone else has to know they're there! It is can work on any smartphone and will integrate seamlessly with a phone's camera

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device; connecting to a camera, displaying an image from the camera on a screen, identifying places on the image to correct, correcting the identifying places, and taking the photo.

2. A system according to claim 1 having the computing device be a smartphone.

3. A system according to claim 1 further comprising marking the identify place once they are corrected.

4. A system according to claim 1 further comprising not taking a photo until the images has been corrected.

5. A system according to claim 1 further comprising adjusting the camera if the image is too large.

6. A system according to claim 1 further comprising having a numbered scale for blemish correction.

7. A system according to claim 1 further comprising allowing a split screen of the image.

8. A system according to claim 1 further comprising having the image stored on the device.

9. A computer application comprising;
having a software that resides in the non-transitory memory of a computing device; connecting to a camera, displaying an image from the camera on a screen, identifying places on the image to correct, correcting the identifying places, and taking the photo.

10. A computer application according to claim 9 having the computing device be a smartphone.

11. A computer application according to claim 9 further comprising marking the identify place once they are corrected.

12. A computer application according to claim 9 further comprising not taking a photo until the images has been corrected.

13. A computer application according to claim 9 further comprising adjusting the camera if the image is too large.

14. A computer application according to claim 9 further comprising having a numbered scale for blemish correction.

15. A computer application according to claim 9 further comprising allowing a split screen of the image.

16. A computer application according to claim 9 further comprising having the image stored on the device.
